(19) United States
(12) Patent Application Publication
(10) Pub. No.: US 2014/0071711 A1
(43) Pub. Date: Mar. 13, 2014

(54) Lighting Module Having Improved Lighting Uniformity

(71) Applicant: Guillaume Boulais, Levallois Perret (FR)

(72) Inventor: Guillaume Boulais, Levallois Perret (FR)

(73) Assignee: GB Developpement, Puteaux (FR)

(21) Appl. No.: 14/008,898

(22) PCT Filed: Mar. 27, 2012
(86) PCT No.: PCT/FR12/50639

§ 371 Date: Sep. 30, 2013

(30) Foreign Application Priority Data
Mar. 30, 2011 (FR) 11 52632

(51) Int. Cl. F21V 8/00

(52) U.S. Cl. CPC G02B 6/0073; G02B 6/0065
USPC 362/613; 29/592.1; 29/825

(57) ABSTRACT

The present invention relates to a lighting module including
at least one strip of light emitting sources,
a light guide having a transmitting face arranged to transmit, to an object to be lit, the light emitted by the emitting sources, and a return face facing the transmitting face (4). The emitting sources are located inside the light guide. According to the invention, the module further includes for each light source, a transmitting reflector associated with this source and having a reflecting face directed towards the transmitting face so that the transmitting reflector associated with this source is located between the transmitting face and an emitting surface of this source arranged for the output out of the source of the light emitted by this source.

### TECHNICAL FIELD

The present invention relates to a lighting module comprising strips of light sources. A field of the invention is more particularly, but not limitedly, that of lighting modules comprising strips of LED.

Such a module can enable a background light to be created for example in a room or as an overhead light of a motorcar. An application area of the invention can for example be in particular that of lighting of shelf in furniture contents, or lighting of a room in replacement of a set of neon tubes.

Such a module can also enable various objects to be backlit, for example a small tag in a supermarket department or a large advertising poster in a street. An application area of the invention can for example be more particularly that of backlighting commercial signs, advertising posters or roadsigns, or even that of backlighting LCD screens in particular large size screens.

### STATE OF PRIOR ART

Lighting modules comprising LED (Light Emitting Diode) rows are known, such as for example described in document WO 2009/125104.

Such a module comprises a light guide and, inside the light guide, at least one row of LED emitting light along a main direction which is contained in the light guide.

In such a module, an issue of homogeneity of the light emitted by this module is often met. Indeed, most often:
either the rows of LED are visible from outside the module, and the module has too high brightness areas at each row of LED with respect to the rest of the guide,
or it is attempted to hide each row of LED (for example with a filter), but there is then the risk that the reverse effect occurs (that is that the module has too low brightness areas at each row of LED with respect to the rest of the guide), and/or that a distortion of the light spectrum occurs by passing through this filter and/or an uneven visual appearance occurs due to cumulated inaccuracies (luminance dispersion and position of the filter).

The object of the invention is to solve at least partly this issue of homogeneity of the light exiting from such a lighting module.

### DESCRIPTION OF THE INVENTION

This purpose is achieved with a lighting module comprising:
at least one strip of lighting emitting sources,
a light guide comprising a transmitting face arranged to transmit to an object to be lit, light emitted by the emitting sources and a return face facing the transmitting face.

The emitting sources are preferably located inside the light guide.

Each strip of sources preferably comprises at least one row of aligned sources. In particular, each strip of sources can comprise at least one row of light sources emitting light substantially in a same direction of emission. Each strip of sources can further comprise a second row of light sources, the sources of the first row preferably emitting light in a direction of emission substantially opposite to a direction of light emission of the sources of the second row. Both rows of sources can be arranged so that the sources of the first row are, with respect to the sources of the second row:
back to back, that is the sources of the first row emit light in a direction of emission substantially opposite to a direction connecting the first row to the second row, or
face to face, that is the sources of the first row emit light substantially in a direction of emission connecting the first row to the second row, or
aligned.

According to a first aspect of the invention, the module according to the invention preferably comprises for each light source, a transmitting reflector associated with this source and having a reflecting face directed towards the transmitting face so that the transmitting reflector associated with this source is located between the transmitting face and an emitting surface of this source arranged for the output out of the source of the light emitted by this source.

Each transmitting reflector is preferably a reflector comprising a reflecting white layer, or can possibly comprise a metal reflector.

Each transmitting reflector can be integrated in the module so that there is no intermediate space, in particular no vacuum, air or gas space, between the light guide and each transmitting reflector.

Each transmitting reflector can have a convex shape towards the transmitting face.

According to a second aspect of the invention, the module according to the invention preferably comprises for each light source a return reflector, associated with this source, and having a reflecting face directed towards the return face so that the emitting surface of this source is located between the return reflector associated with this source and the return face.

Each return reflector can be a reflector having a reflecting white layer, or can be a metal reflector.

For each source, the reflecting face of the return reflector associated with this source can be tilted so that the distance between the return face and this reflecting face is increasing as the distance from the strip carrying this source increases.

For each strip of sources, the return reflectors of the different sources can form:
mutually discontinuous reflecting areas, or
a continuous reflecting strip running along the rows of sources of the strip of sources and common to all these rows, or
a continuous reflecting strip per row of sources of the strip of sources, each reflecting strip running along its row, the reflecting strips of a same strip of sources being spaced by a non-reflecting intermediate space letting the light through.

Each reflecting strip is preferably provided, along its edge farthest from the light sources of this strip of sources, with a non-reflecting dark strip arranged to absorb light emitted by the sources.

For each light source, the transmitting reflector and return reflector associated with a same source are preferably located on two opposite faces of a same object such as a film or profile.

Each strip of sources can comprise a power supply circuit carrying the sources of this strip of sources, and:
for each strip of sources, the emitting sources of the strip of sources can be included between the transmitting face and the circuit of this strip of sources, or
for each strip of sources, the circuit of the strip of sources can be included between the transmitting face and the emitting sources of this strip of sources.

According to another aspect of the invention, a method is provided for making a module according to the invention, characterised in that it comprises the following steps:
in a space bounded between two surfaces at least one assembly is placed, a first of these surfaces bounding a return face, a second of these surfaces bounding a transmitting face, each assembly comprising:
   a strip of light emitting sources (and preferably integral with each other), and
   for each of the sources of this strip:
      a transmitting reflector associated with this source (and preferably integral with its source) and having a reflecting face directed towards the transmitting face so that the transmitting reflector associated with this source is located between the transmitting face and an emitting surface of this source arranged for the output out of the source of the light emitted by this source, and/or
      a return reflector associated with this source (and preferably integral with its source) and having a reflecting face directed towards the return face so that the emitting surface of this source is located between the return reflector associated with this source and the return face.
the space is filled with an initially liquid or pasty material to form a light guide, so that the emitting sources are located inside the light guide,
this material is solidified, and
the guide, integral with each assembly, is demoulded by removing it from between both surfaces.

If transmitting reflectors and return reflectors are both present, then, for each assembly, the transmitting reflectors and return reflectors associated with all the sources of an assembly are preferably located on two opposite faces of a same object such as a film or a profile.

The surface bounding the return face is preferably in contact with each assembly.

The surface bounding the transmitting face is preferably not in contact with any assembly.

Each strip of sources can comprise at least one first row of light sources emitting light substantially in a same direction of emission, and further a second row of light sources (preferably parallel to the first row), the sources of the first row emitting light in a direction of emission substantially opposite to a direction of light emission of the sources of the second row.

Each assembly can further include a power supply carrying the sources of the strip of sources of this assembly.

In this case:
for each strip of sources, once it is placed between both surfaces, the circuit of the strip of sources can be comprised between the transmitting face and the emitting sources of this strip of sources, or
for each strip of sources, once it is placed between both surfaces, the emitting sources of the strip of sources can be comprised between the transmitting face and the circuit of this strip of sources.

Both surfaces can be connected by a seal closing the space.

### DESCRIPTION OF THE FIGURES AND EMBODIMENTS

Further advantages and features of the invention will appear upon reading the detailed description of implementations and embodiments in no way limiting, and in the following appended drawings wherein:

FIG. 1 is a cross-sectional side view of a first preferable embodiment of the lighting module according to the invention,

FIG. 2 is a three-quarter view of one of the strips of “side view” LED of the module of FIG. 1, comprising several rows of back to back sources 2,

FIG. 3 is a cross-sectional side view of a part 100 of the first embodiment of FIG. 1,

FIG. 4 is a cross-sectional side view of a second embodiment of the lighting module according to the invention,

FIG. 5 is a cross-sectional side view of a third embodiment of the lighting module according to the invention,

FIG. 6 is a cross-sectional side view of a fourth embodiment of the lighting module according to the invention,

FIG. 7 is a cross-sectional side view of a fifth embodiment of the lighting module according to the invention,

FIG. 8 is a cross-sectional side view of a sixth embodiment of the lighting module according to the invention,

FIG. 9 is a bottom view of the reflectors 12, 15 superimposed with rows of sources 2 of a strip 7 of sources, for an alternative of one of the first to sixth illustrated embodiments of the module,

FIG. 10 is a three-quarter view of one of the strips of “side view” LED comprising several rows of face to face sources 2,

FIG. 11 is a graph illustrating the luminance at the transmitting face along a straight line perpendicular to the rows of sources, for the module of FIG. 6,

FIGS. 12 to 16 illustrate different steps of a method for making the module described in reference to FIG. 3,

FIG. 17 illustrates an alternative of the module of FIG. 3, and

FIG. 18 is a three-quarter view of one of the “front view” strips of LED.

These embodiments being in no way limiting, alternatives of the invention could in particular be considered which only comprise a selection of characteristics described in the following isolated from the other described characteristics (even if this selection is isolated within a sentence comprising these other characteristics), if this selection of characteristics is sufficient to provide a technical advantage or differentiate the invention with respect to the state of prior art. This selection comprises at least one preferably functional characteristic without structural details, or with only part of the structural details if only this part is sufficient to provide a technical advantage or to differentiate the invention with respect to the state of prior art.

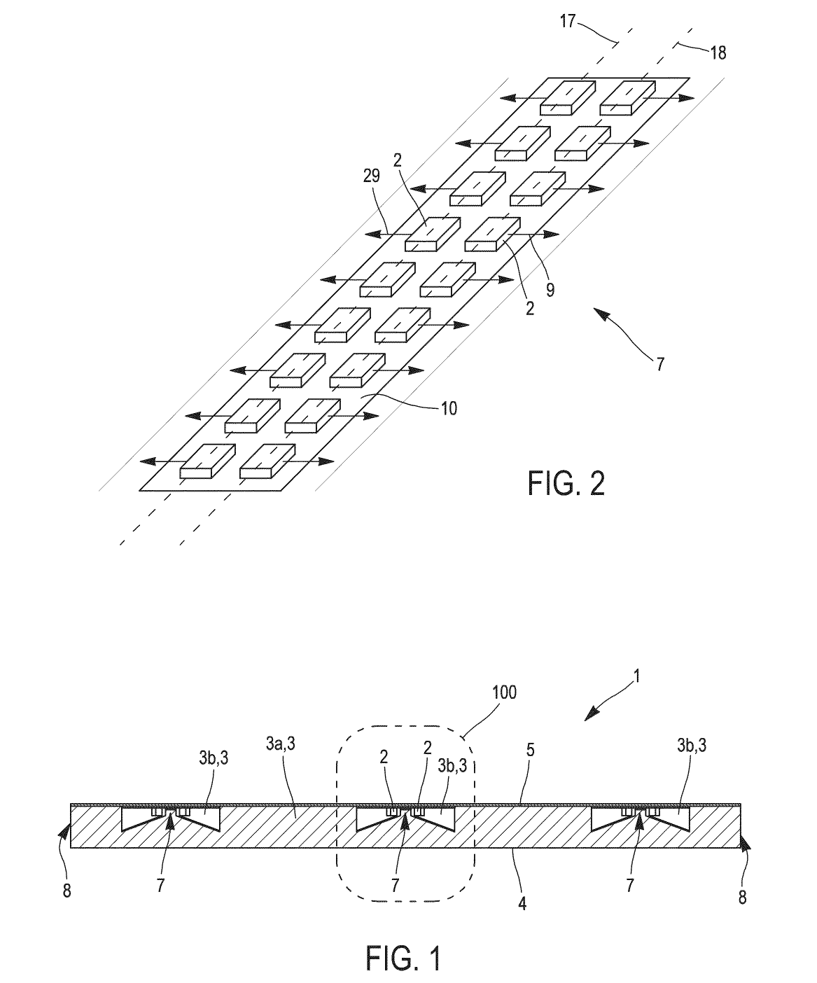

It will be first described, in reference to FIGS. 1 to 3, a first preferred embodiment of the lighting module 1 according to the invention.

The module 1 can be used for:
creating a background light for example in a room or as an overhead light in a motorcar,
lighting the shelf or furniture contents, the module 1 being flat, not bulky and emitting little heat,
lighting a room or objects in replacement of a set of neon tubes,
backlighting various objects, for example a small tag in a supermarket department or a large advertising poster in a street,
backlighting a commercial sign, and advertising poster or a roadsign, or
backlighting a LCD screen in particular a large size LCD screen.

The lighting module 1 comprises several parallel strips 7 of light emitting sources 2. Besides its own sources 2, each strip 7 comprises a power supply printed circuit 10 carrying the sources 2 of this strip 7 and arranged to electrically power these sources 2. This circuit 10 is typically:
either a flexible circuit, also called “flex”, comprising a film of polyamide such a Kapton® film from Du Pont of a few tens of micrometres thickness (typically 0.1 mm),
or a thin circuit, preferably of a thickness lower than 0.5 mm, typically in a reflecting plastic material such as a FR4 type epoxy resin.

Each source 2 is a LED (Light Emitting Diode). Each of the emitting sources 2 is a “side view” type LED, that is an emitting source arranged to emit light in a direction of emission 9 or 29 substantially parallel to the portion of the circuit 10 carrying said emitting source. These sources have a typically thickness between 0.2 millimetre and 2 millimetres, and can for example comprise “side view” LED model no NSSW208T thickness 0.8 mm or NSSW105T thickness 0.5 mm from Nichia Corporation.

FIG. 2 illustrates one of the strips 7 of the module 1. Each strip 7 comprises several rows of sources 17, 18. Each row 17 or 18 of sources comprises emitting sources 2 substantially aligned along a direction of alignment.

In the present embodiment, each strip 7 only comprises two rows 17, 18 of sources 2: a first row 18 of sources 2 which are arranged to emit light substantially in a same direction of emission 9, and a second row 17 of sources 2 which are arranged to emit light substantially in a same direction of emission 29, the sources 2 of the first row emitting light in a direction of emission 9 substantially opposite to the direction of emission 29 of the sources of the second row. Each direction of emission 9 or 29 of a source 2 is a direction to which is centred the solid angle of emission of the light emitted by this source 2. Each direction of emission 9 or 29 is parallel to the return face 5. Each direction of emission 9 or 29 is parallel to the transmitting face 4.

The module 1 further comprises a light guide 3 comprising:
a transmitting face 4 arranged to transmit to an object to be lit (for example background light) or backlit (for example an advertising poster or a number plate) of the light emitted by the emitting sources 2, and
a return face 5 facing the transmitting face 4.

Each face of the return 5 or transmitting 4 face can be structured, that is provided with relief structures such as for example structures of side by side spherical caps or pyramids about 1 mm high and about 3 mm wide.

The emitting sources 2 are located inside the light guide 3 between the transmitting face 4 and the return face 5. The emitting sources 2 are inserted inside the guide 3 from the return face 5.

Each source 2 is arranged to emit light along a direction of emission contained in the light guide 3.

The light guide 3 comprises two parts:
a main part 3a, made of a transparent material that is substantially not absorbing light emitted by the emitting sources 2 so as to guide this light out of the guide 3; and
for each strip 7, a cavity 3b recessed in the main part 3a and arranged to accommodate a strip 7.

Upon making the module 1, each cavity is initially empty, and is then filled with a transparent filling material, said filling material being initially liquid or pasty and solidified after the emitting sources are inserted into the cavities 3b. Thus, the emitting sources 2 are located in the guide 3 without intermediate space between the guide 3 and the emitting sources 2, in particular without air space. The material of the guide 3 preferably comprises PMMA (polymethylmethacrylate), polycarbonate (PC) and/or polyester. The thickness of the guide 3 is for example 4 millimetres (typically between 0.3 mm and 10 mm). This filling is optional but is very advantageous, because it improves a lot the coupling, inside the rest 3a of the guide, of the light emitted by the sources 2. This filling material is preferably the same as the material of the main part 3a.

The printed circuits 10 further comprise electrical resistors (not represented in the figures) electrically connected to the emitting sources 2, typically one resistor per group of three LED type emitting sources. Typically, there is one resistor per group of four LED type emitting sources and for a direct current 14V power supply.

The light sources are advantageously driven by an electronic driver, for example of the NUMEN Technology brand, for example reference NU501 of the SOT 23-3, SOT 23-5 or SOT 89-3 types.

The guide 3, that is the main part 3a and the cavities 3b, is preferably made according to a method such as described in document WO 2009/125104 or preferably by extrusion such as described in French patent application no 1053733.

The module 1 further comprises means 6 for returning to the inside of the guide 3 the light emitted by the emitting sources 2, said returning means 6 being provided on the return face 5 side. This means typically comprises:
a paint layer or reflecting ink, being preferably white, directly made on the return face 5, or
a reflecting film directly laminated on the return face.

Thus, according to the invention, moister or dust can be prevented from infiltrating between the return face 5 and the reflecting means 6.

Moreover, the use according to the invention of the reflecting film or a painting or ink on the return face, with respect to the use according to the state of prior art of laser etched grooves:
has the advantage of providing a higher total luminance, and thus a better lighting, but
has the disadvantage of providing a less homogeneous lighting, however, this drawback is of lesser importance because the invention enables strips of light sources to be provided inside the guide sufficiently close to each other to prevent this inhomogeneity to be too visible (typically between 10 and 15 centimetres between two strip of sources).

The return means 6 are plated or glued against the return face 5, without intermediate space or at least mostly (that is for more than 50% of the area) without intermediate space, in particular no vacuum, air or gas space, between the return means 6 and the return face 5.

Each direction of emission 9 or 29 of the source 2 does not intersect, starting from this source 2, the transmitting 4 or return 5 face by being perpendicular to that face, but rather is either substantially parallel to the transmitting 4 or return 5 face, or slightly oblique to the transmitting 4 or return 5 face.

The guide 3 has substantially a plate shape comprising two opposite faces bordering the guide: the substantially planar transmitting face 4 and the substantially planar return face 5. This plate is flexible, and can be flattened or assume curved shapes. The transmitting face 4 is arranged to let the light emitted by the emitting sources 2 inside the guide 3 through and transmit out of the guide 3 to an object to be lit. The object to be lit is located out of the guide 3, on the transmitting face 4 side with respect to the guide 3. As a particular lighting type, this object can be backlit, that is it is located between the viewer and the guide 3. The return face 5 faces the transmitting face 4. The return face 5 is substantially parallel to the transmitting face 4. The guide 3 further comprises a boundary surface 8 (also called side edges) connecting the transmitting face 4 to the return face 5, so that the emitting sources 2 are located inside the guide 3 by being surrounded by the boundary surface 8.

The module 1 further comprises for each light source 2 a transmitting reflector 12 associated with this source and extending at least partly along a direction parallel to the transmitting face 4. This transmitting reflector has a reflecting face 13 directed towards the transmitting face 4 so that the transmitting reflector 12 associated with this source is located between the transmitting face 4 and an emitting surface 14 (illustrated in dotted lines) of this source, this emitting surface 14 being arranged for the output out of the source of the light emitted by this source 2. Each transmitting reflector 12 is preferably a white reflector comprising a light reflecting white surface, typically a reflecting thin white ink or paint layer. Each transmitting reflector 12 is a reflector reflecting the light emitted by the sources 2. By reflecting, it is preferably meant, in this description, reflecting more than 90% of the light visible to human eye (i.e. 400 nm to 700 nm wavelength). Each transmitting reflector is opaque. By opaque, it is preferably meant in this description which does not let the light visible to human eye through it, more concretely, which prevents at least 90% of the light visible to human eye from passing through it.

Each transmitting reflector 12 is arranged to form a screen between, on the one hand, the source 2 with which it is associated and, on the other hand, the transmitting face 4. Such a screen avoids creating a too luminous light strip at each strip 7 of sources with respect to the rest of the guide 3. However, such a simply opaque screen is likely to transform a too luminous light strip at each strip 7 with respect to the rest of the guide 3 into too dark a light strip with respect to the rest of the guide 3. The fact that the “screen” formed by each transmitting reflector 12 is further arranged to reflect light towards the transmitting face enables this risk of under-exposure to be overcome.

Each transmitting reflector 12 is integrated in the module 1 and inside the light guide 3 so that there is no intermediate space, in particular no vacuum, air or gas space, between the light guide 3 and each transmitting reflector. The fact that there is no air enables much more light to go out than in the presence of air thanks to direct reflection on the transmitting reflector 12.

The module 1 further comprises for each light source a return reflector (or mirror) 15 associated with this source having a reflecting face 16 directed towards the return face 5 so that the emitting surface 14 of this source is located between the return reflector 15 associated with this source and the return face 5. Each return reflector 15 extends at least partly along a direction parallel to the return face. Each return reflector 15 is preferably a metal reflector, typically comprising a thin metal deposit reflecting layer, but can in some alternatives, be a white reflector comprising a light reflecting white surface, typically a thin reflecting white ink or paint layer. Each return reflector 15 is preferably a reflector reflecting more than 90% of the light visible to human eye (i.e. 400 nm to 700 nm wavelength). Each return reflector 15 is opaque, that is it does not let the light visible to human eye through it. More concretely, it prevents at least 90% of the light visible to human eye from passing through it.

Each return reflector 15 enables “the release” of the light emitted by the source 2 associated to it to be improved, so that this light is not trapped under the opaque screen formed by the transmitting reflector 12 or the return reflector 15 associated with this source 2.

Each return reflector 15 is arranged to form a screen between, on the one hand, the source 2 with which it is associated and, on the other hand, the transmitting face 4. Each return reflector 15 is integrated in the module 1 and inside the light guide 3 so that there is no intermediate space, in particular no vacuum, air or gas space, between the light guide and the transmitting reflector.

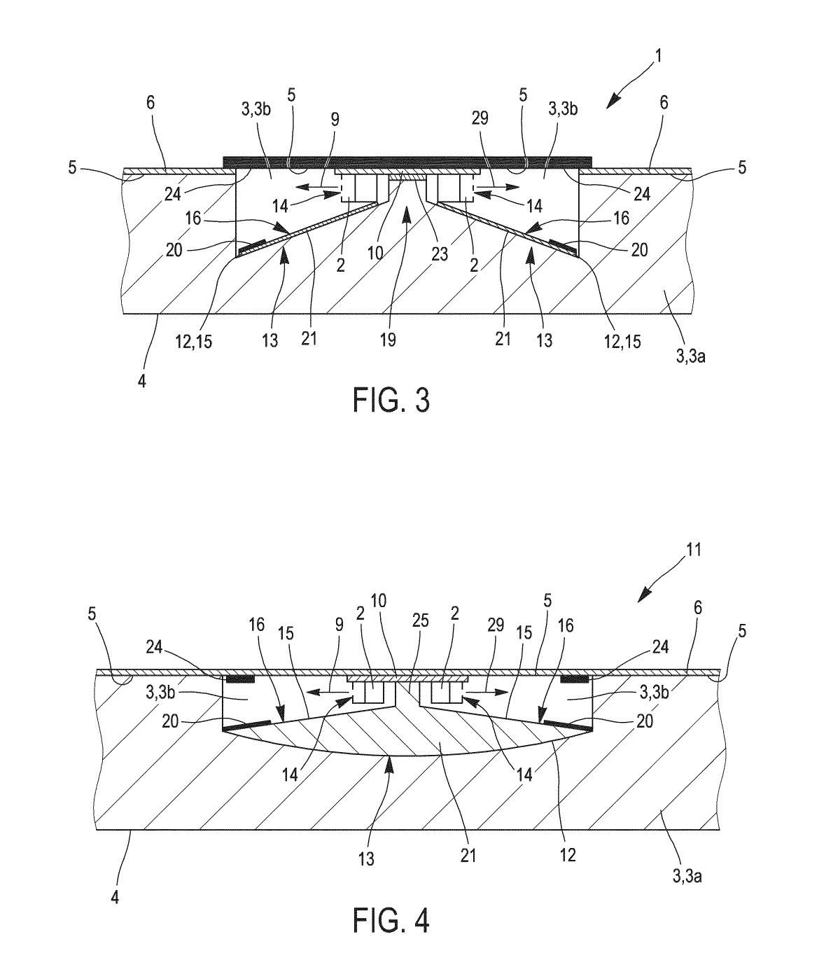

For each light source 2, these associated transmitting reflector 12 and return reflector 15 are located on 2 opposite faces of an object 21 provided at the bottom of the cavity 3b wherein this source 2 is inserted. This object 21 is preferably transparent to the light of the sources 2. More exactly, the transmitting reflector 12 and the return reflector 15 which are associated with a same source 2 are located on 2 opposite faces of a same film such as illustrated in FIG. 3. For each strip 7, there is one film per row of sources of the strip 7, each film extending along one of its rows. Each film is typically:
either a plastic film deposited (and preferably glued) at the bottom of the cavity 3b, for example a white PET (polyethylene terephthalate) layer with a deposited (preferably under vacuum) metal layer on one of the faces of the PET layer, or two white PET layers and a deposited (preferably under vacuum) metal layer between both PET layers, or a COTAC GIN 137 film,
or a reflecting white paint or ink film, directly made at the bottom of a cavity 3b, typically by spraying paint or ink on the bottom of the cavity 3b.

As illustrated in FIG. 3, for each source 2, the reflecting face 16 of the return reflector 15 associated with this source is tilted at the beginning of this source so that the distance between the return face 5 and this reflecting face 16 is increasing as the direction of emission 9 or 29 of light of this source is travelled and as the distance from the strip carrying this source increases. This enables the light not to be “enclosed” or “trapped” under the reflectors 12, 15, and rather enables the “release” of this light to be improved, that is the coupling in the guide.

For each strip 7 of sources 2, the return reflectors 15 of the different sources form a continuous reflecting strip per row 17, 18 of sources of the strip of sources, this reflecting strip running along its row 17, 18 respectively (that is extending along the direction of alignment of its row), the reflecting strips of a same strip of sources being spaced by a non-reflecting intermediate space 19 letting the light through. Thus, the homogeneity of brightness is improved, by avoiding that the middle of each strip 7 of sources be too dark.

For each strip 7, between both rows 17, 18 of sources of this strip 7, the module 1 comprises means 23 reflecting the light from this strip 7 to the intermediate space 19 between reflecting strips of these rows 17, 18. These means typically comprise either:
a plastic film deposited on each circuit 10 between the rows of sources, for example a white PET (polyethylene terephthalate) layer with a deposited (preferably under vacuum) metal layer on one of the faces of the PET layer, or two white PET layers and a deposited (preferably under vacuum) metal layer between both PET layers, or a COTAC GIN 137 film,
or a reflecting white paint or ink film, directly made on each circuit between the rows of sources, typically by spraying paint or ink.

Each reflecting strip is provided, along its edge farthest from the light sources of this strip of sources, with a non-reflecting dark strip 20 arranged to absorb the light emitted by the sources. Each dark strip 20 enables to soften the brightness jump between the end of the reflecting strip and the rest of the guide 3 caused by the interface between the outer edge of the cavity 3b and the rest of the guide 3.

Furthermore, for each strip 7 of sources, the transmitting reflectors 12 of different sources form a continuous reflecting strip per row 17, 18 of sources of the strip of sources, this reflecting strip running along its row 17 or 18 respectively, the reflecting strips of a same strip of sources being spaced by a non-reflecting intermediate space 19 letting the light through. Thus, the homogeneity of brightness is improved, by avoiding that the middle of each strip 7 of sources be too dark.

The light guide 3 is provided, for each row of light sources, with a non-reflecting dark strip 24 arranged to absorb the light emitted by the sources and provided on the return face side under the transmitting reflector 12 associated with this row of sources, more exactly at least under the length of the edge of this transmitting reflector 12 farthest from the light sources of this row of sources. Each dark strip 24 enables to soften a brightness jump between the end of a reflecting strip and the rest of the guide 3 caused by the interface between the outer edge of the cavity 3b and the rest of the guide 3a.

It is noted that in the module 1, in reference to FIG. 3, for each strip 7 of sources, the emitting sources 2 of this strip 7 of sources are included between the transmitting face 4 and the power supply circuit 10 carrying the sources of this strip of sources.

It will now be described, in reference to FIG. 4, a second embodiment of the module 11 according to the invention, only as to its differences with respect to the first embodiment of the module 1 of FIGS. 1 to 3. Just like FIG. 3, FIG. 4 only illustrates part of the module according to the invention, centred on a strip 7 of sources.

In the module 11, for each light source, the associated transmitting reflector and return reflector are located not on two opposite faces of a same film, but on two opposite faces of a same profile 21. For each strip 7, there is a profile 21 common to all the rows of sources of the strip 7, this profile extending along the direction of alignment of at least one of the rows of sources of this strip 7.

This profile 21 is of a reflecting material, preferably a material reflecting more than 90% of the light visible to human eye. This material is typically white, and comprises for example a plastic material such as acrylonitrile butadiene styrene copolymer.

The face 16 of the profile is a metallized face, that is provided with a reflecting metal layer.

Furthermore, in the module 11, each transmitting reflector 12 has a convex shape towards the transmitting face 4, due to a convex shape of this profile towards the transmitting face.

Furthermore, in the module 11, for each strip 7 of sources, the transmitting reflectors 12 of different sources form a continuous reflecting strip running along the rows of sources of the strip of sources and common to all these rows.

In one alternative, on the contrary, the profile 21 is of transparent material, letting the light through, typically letting at least 50% or even at least 90% of the light through. Such a profile enables the light to be made uniform because the light is distributed inside the profile between the reflectors 12 and 15.

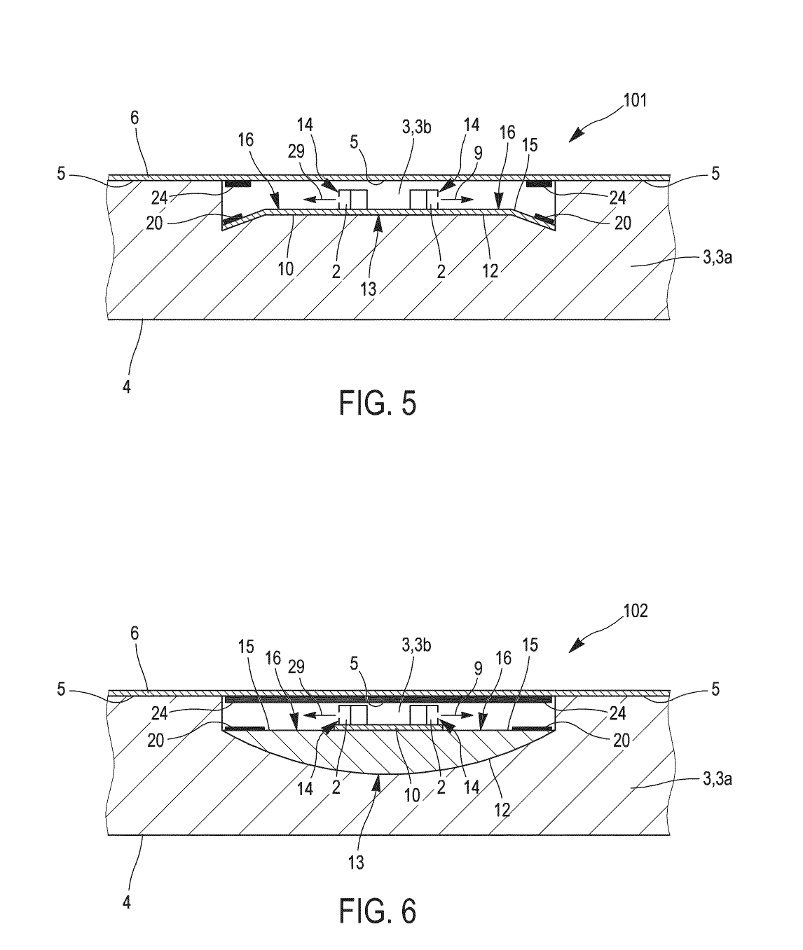

It will now be described, in reference to FIG. 5, a third embodiment of the module 101 according to the invention, only as regards its differences with respect to the first embodiment of the module 1 of FIGS. 1 to 3. Just like FIG. 3, FIG. 5 only illustrates part of the module according to the invention, centred on a strip 7 of sources.

In the module 101, for each strip of sources, the power supply circuit 10 carrying the sources of this strip of sources is included between the transmitting face 4 and the emitting sources 2 of this strip 7 of sources.

Furthermore, in the module 101, for each strip 7 of sources, the transmitting reflectors 12 of different sources form a continuous reflecting strip running along the rows of sources of the strip of sources and common to all these rows.

Moreover, in the module 101, for each strip 7 of sources, the return reflectors 15 of different sources form a continuous reflecting strip running along the rows of sources of the strip of sources and common to all these rows.

Furthermore, in the module 101, for each light source 2, the object 21 on the faces of which are located the transmitting reflector 12 and the return reflector 15 is the circuit 10 carrying this source 2. Each circuit 10 is thus provided with two reflecting surfaces:
a face of the circuit 10, directed towards the transmitting face 4, is provided with the reflecting face 13 of the transmitting reflector 12 (preferably a white reflector); this reflecting face can be due either to the reflecting material making up the circuit 10, or the reflecting paint or ink distributed on this face of the circuit 10; and independently
a face of the circuit 10, directed towards the return face 5, is provided with the reflecting face 16 of the return reflector 15 (preferably a white reflector); this reflecting face can be due either to the reflecting material making up the circuit 10, or to the reflecting paint or ink distributed on this face of the circuit 10.

Finally, for each source 2, the reflecting face 16 of the return reflector 15 associated with this source is at first not tilted, so that the distance between the return face 5 and this reflecting face 16 is constant when the direction of emission 9 or 29 of the light of this source is followed and as the distance from the strip carrying this source increases, and then is tilted after some distance so that the distance between the return face 5 and this reflecting face 16 is increasing when the direction of emission 9 or 29 of the light of this source is followed and as the distance from the strip carrying this source increases.

It will now be described, in reference to FIG. 6, a fourth embodiment of the module 102 according to the invention, only as regards its differences with respect to the second embodiment of the module 11 of FIG. 4. Just like FIG. 3, FIG. 6 only illustrates part of the module according to the invention, centred on a strip 7 of sources.

In the module 102, for each strip of sources, the power supply circuit carrying the sources of this strip of sources is included between the transmitting face and the emitting sources of this strip of sources.

Moreover, in the module 102, for each strip 7 of sources, the transmitting reflectors of different sources form a continuous reflecting strip running along the rows of sources of the strip of sources and common to all these rows.

Furthermore, in the module 102, for each strip 7 of sources, the return reflectors of different sources form a continuous reflecting strip running along the rows of sources of the strip of sources and common to all these rows.

Finally, for each source 2, the reflecting face 16 of the return reflector 15 associated with this source is not tilted, so that the distance between the return face and this reflecting face 16 is constant when the direction of emission 9 or 29 of the light of this source is followed and as the distance from the strip carrying this source increases.

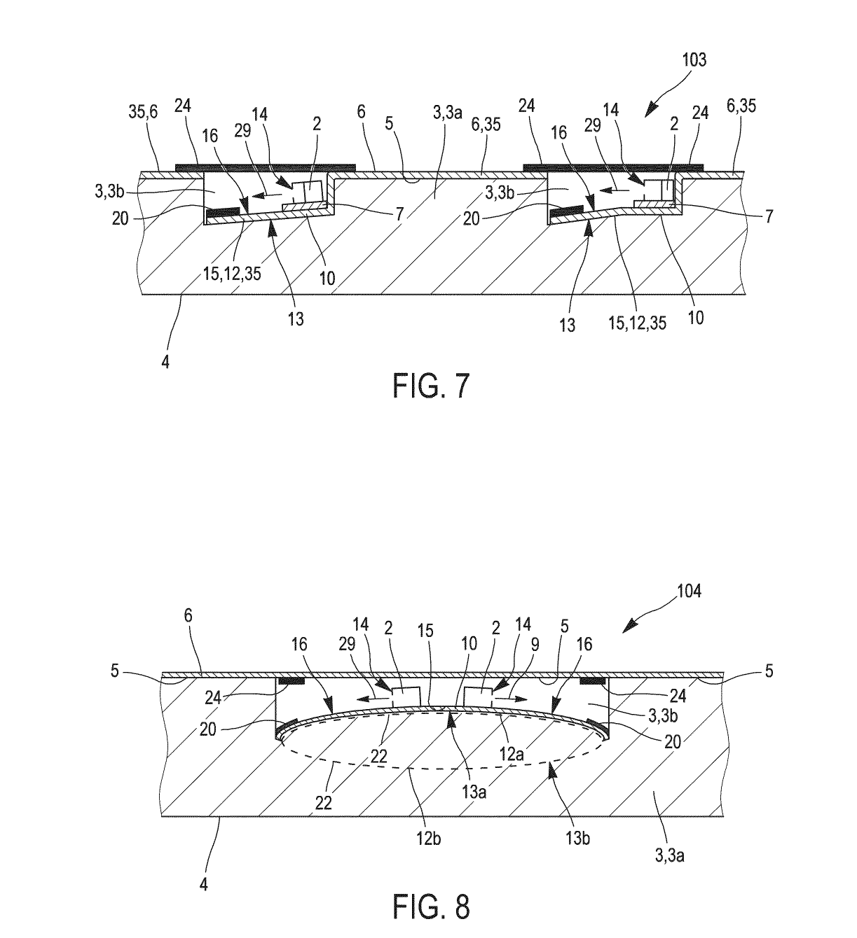

It will now be described, in reference to FIG. 7, a fifth embodiment of the module 103 according to the invention, only as regards its differences with respect to the third embodiment of the module 101 of FIG. 5. Just like FIG. 3, FIG. 7 only illustrates part of the module according to the invention, centred on two strips 7 of sources.

In the module 103, each strip 7 only includes a single row of light sources 2.

In the module 103, the direction of emission 29 of at least some sources 2 is neither parallel to the transmitting face 4, nor parallel to the return face 5.

Finally, for each source 2, the reflecting face 16 of the return reflector 15 associated with this source is tilted so that the distance between the return face 5 and this reflecting face is increasing when the direction of emission 29 of the light of this source is followed and as the distance from the strip carrying this source increases.

It will now be described, in reference to FIG. 8, a sixth embodiment of the module 104 according to the invention, only as regards its differences with respect to the third embodiment of the module 101 of FIG. 5. Just like FIG. 3, FIG. 8 only illustrates part of the module according to the invention, centred on a strip 7 of sources.

In the module 104, the direction of emission 9 or 29 of at least some sources 2 is neither parallel to the transmitting face 4, nor parallel to the return face 5.

Finally, for each source 2, the reflecting face 16 of the return reflector 15 associated with this source is tilted so that the distance between the return face 5 and this reflecting face 16 is increasing when the direction of emission 9 or 29 of the light of this source is followed and as the distance from the strip carrying this source increases.

In an alternative such as illustrated in FIG. 8, the case where each circuit 10 is directly contacting the guide 3 on the transmitting face 4 side can be considered. In this case, each circuit 10 is thereby provided with two reflecting faces:
a face of the circuit 10, directed towards the transmitting face 4, is provided with the reflecting face 13a of the transmitting reflector 12a (preferably a white reflector); and independently
a face of the circuit 10, directed towards the return face 5, is provided with the reflecting face 16 of the return reflector 15 (preferably a white reflector).

In another alternative, a case where each circuit 10 is laid onto a profile the boundaries of which are illustrated by the dotted lines 22 can be considered. In this case, each circuit 10 is thereby provided with a reflecting face: a face of the circuit 10, directed towards the return face 5, is provided with the reflecting face 16 of the return reflector 15 (preferably a white reflector). The profile, in turn, has a face directed towards the transmitting face 4, which is provided with the reflecting face 13b of the transmitting reflector 12b (preferably a white reflector).

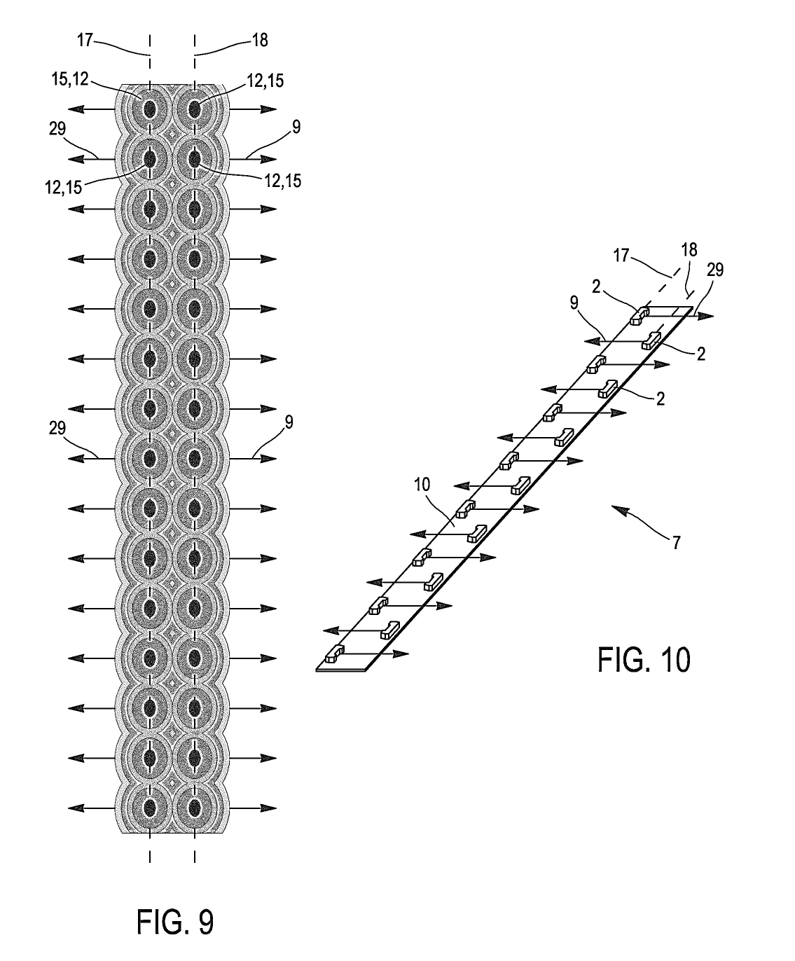

It will now be described, in reference to FIG. 9, an alternative of any of the embodiments of the module according to the invention just described, only as regards its differences with respect to these embodiments.

In this alternative, for each strip of sources, the return reflectors 15 of the different sources form reflecting areas being discontinuous between each other. In other words, each return reflector 15 associated with a source is distinct from the return reflectors associated with the other sources, and is separated from the return reflectors associated with other sources by an intermediate space letting the light through. Each return reflector 15 associated with a source 2 has a reflection coefficient which is maximum at a centre (which is typically the point of the reflector 15 that is closest to this source 2), and which decreases as the distance from this centre increases.

Furthermore, in this alternative, for each strip of sources, the transmitting reflectors 12 of the different sources form reflecting areas which are discontinuous between each other. In other words, each transmitting reflector 12 associated with a source is distinct from the transmitting reflectors 12 associated with the other sources, and is separated from the transmitting reflectors 12 associated with the other sources by an intermediate space letting the light through. Each transmitting reflector 12 associated with a source 2 has a reflection coefficient which is maximum at a centre (which is typically the point of the reflector 12 that is closest to this source 2), and which decreases as the distance from this centre increases.

In FIG. 9 is represented the decrease in reflection coefficients by a grey scale from black to lighter shades.

FIG. 10 is a three quarter view of one of the strips of “side view” LED, comprising several rows of face-to-face sources 2. Any of the described embodiments or alternative of the invention can be modified by replacing one, several or each strip(s) according to FIG. 2 by a strip according to FIG. 10.

This is applicable in particular in the case of FIG. 4 where the rows 17, 18 of sources of each strip 7 are separated by a rib 25 (here more particularly a rib of the profile 21) reflecting the light emitted by the sources, preferably reflecting more than 90% of the light visible to human eye.

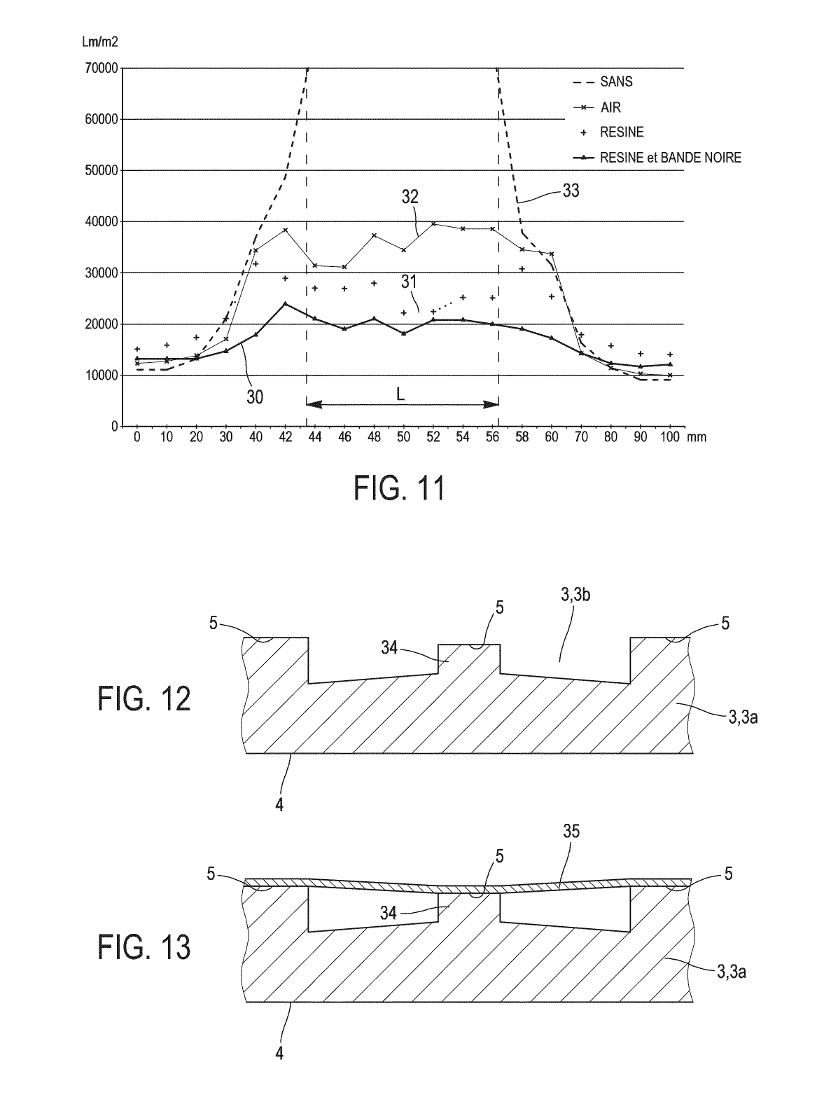

FIG. 11 is a graph illustrating the luminance at the transmitting face 4, along a straight line perpendicular to the rows 17, 18 of sources of a strip of sources, on a 100 mm distance (abscissa axis) comprising a single strip centred on the 50 mm position:
for the module of FIG. 6 (curve 30) free from dark strips 20,
for an alternative of FIG. 6 free from dark strips 20 and 24 (curve 31); it can be seen by comparison with the curve 30 that these dark strips planarise the curve (improvement of the homogeneity) in particular at the edges of the reflectors, but that the efficiency is a little reduced,
for an alternative of FIG. 6 free from dark strips 20 and 24 and having a cavity 3b not filled with material, but filled with air (curve 32); it can be seen by comparison with the curve 31 that the filling of the cavity 3b by a material such as a resin making up the rest 3a of the guide improves the coupling (efficiency) and homogeneity of the light in the guide,
for an alternative of FIG. 6 free from dark strips 20 and 24 and having a cavity 3b not filled with material, but filled with air, and free from the reflectors 12 and 15 (curve 33); it can be seen by comparison with the curve 32 that these reflectors dramatically planarise the curve (improvement of the homogeneity).

The ordinate axis represents a luminance in lumen/m².

The width L of the rib or cavity 3b is 13 mm.

On the abscissa axis, the scale is expanded between 40 and 60 mm.

It will now be described, in reference to FIGS. 12 to 16, different steps of a method of making a module described in reference to FIG. 3.

In reference to FIG. 12, first the main part 3a of the guide is made, typically by extrusion such as described in French patent application no 1053733.

The guide 3 comprises at least one cavity 3b, each cavity being for receiving a strip 7 of sources to be inserted into the guide.

Each cavity 3b has a longitudinal trench shape. This trench comprises a groove 34 parallel to the trench (that is extending parallel to the longitudinal direction of the trench) and separating in two this trench and forming a support surface for the light emitting sources (more precisely for the support 10 of the sources 2). Each groove 34 is substantially centred inside its trench. Of course, the groove 34 is only optional, and embodiments free from the groove 34 can be contemplated.

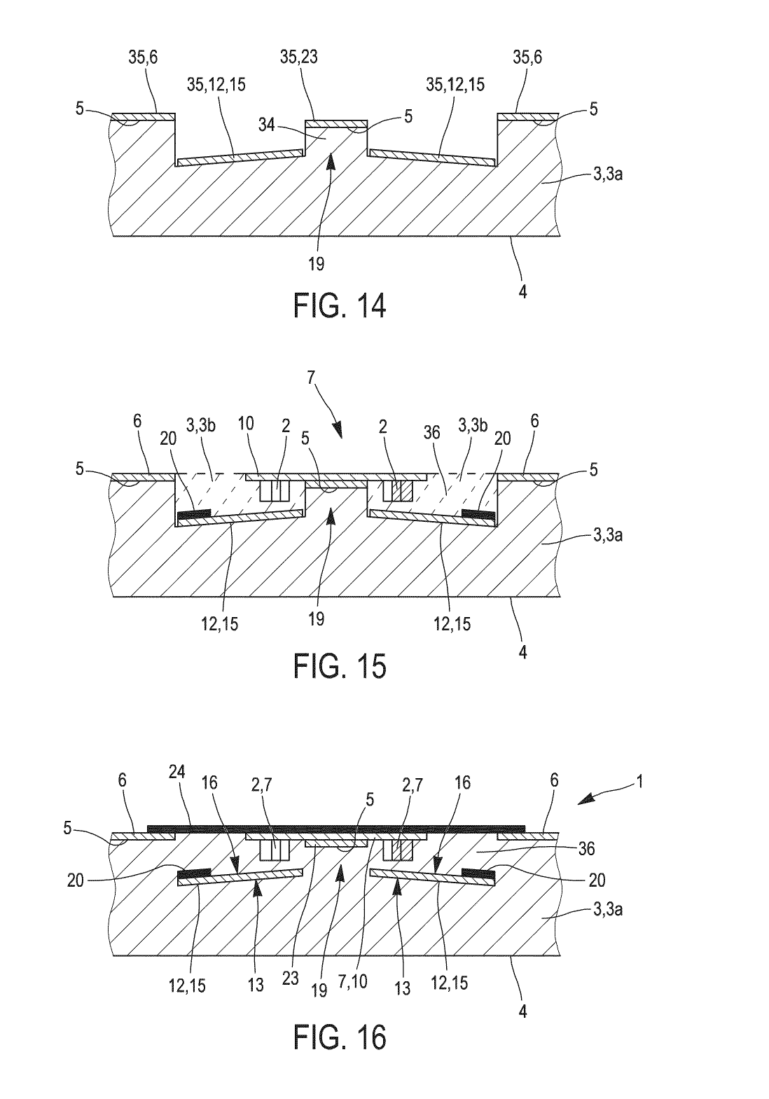

Then, the reflectors 6, 23, 12, 15 are made. For this, several options can be considered:
in reference to FIG. 13, a plate 35 (more or less thin, possibly a film) is made, typically laminated or extruded, of a white reflecting material (for example of PET) which is then plated onto the return face 5; this plate is provided beforehand with glue on its face directed towards the guide 3; and then, in reference to FIG. 14, this plate 35 is cut out of, typically with cutting blades or edges by laminating the plate 35-guide 3 assembly or by crushing the plate 35 onto the guide 3, so that at least one part of the plate 35 is crushed in the bottom of each cavity to form the reflectors 12, 15, and/or part of the plate 35 is crushed against the groove 34 of each cavity to form the reflector 23, and/or part (typically the rest) of the plate 35 is crushed against the return face 5 to form the reflector 6;
in reference to FIG. 14, a reflecting white paint or ink is directly sprayed onto the guide on the return face 5 side is, so as to form the reflectors 12, 15 at the bottom of each cavity, and/or the reflector 23 against the top of the groove 34 of each cavity, and/or the reflector 6 against the return face 5.

Then, optionally, the black strips 20 can be inserted, for example by spraying black ink or paint or as a black glued or pressure sensitive adhesive strip.

Then, in reference to FIG. 15, a strip 7 of light emitting sources is inserted per each trench. The strip 7 is typically inserted by a system of one or more diode row coils, each coil (not illustrated) being arranged (powered) to unwind towards the inside of a trench and thus insert at least one row of light emitting sources in this trench. For each cavity 3b or trench, each couple of neighbouring rows 17, 18 is separated by a groove 34.

For each inserted strip, the space 36 of the cavity 3b separating the strip inserted into this cavity 3b and the rest of the guide 3a is filled with a material which is initially fluid and then solidifies, for example an epoxy resin, or even polymethylmethacrylate (PMMA), or even an ACRYLATE or METHACRYLATE based material such as EPOXY ACRYLATE, EPOXY METHACRYLATE, URETHANE ACRYLATE, URETHANE METHACRYLATE, ACRYLATE, preferably the same material as the rest of the guide 3a. Thus, the intermediate air spaces are avoided, and thereby it is not necessary to treat the inner surfaces of trenches with an antireflection treatment to decrease the light energy losses by reflection. For each cavity to be filled, this space 36 is typically filled by a nozzle or needle (not illustrated) which injects fluid material:
into the trench before inserting the strip 7, the material in the space 36 being still fluid upon inserting the strip and gluing the guide to the strip inserted upon the solidification thereof, or
in the space 36 after the strip has been inserted, the fluid material inserted in the space 36 gluing the inserted strip to the guide 3 upon the solidification thereof.

Then, in reference to FIG. 16, each strip 24 is provided on the return face 5 side.

It is noted that this method of making according to the invention by combination of the main part 3a and the part 35 is applicable to the module according to the invention illustrated in FIG. 7.

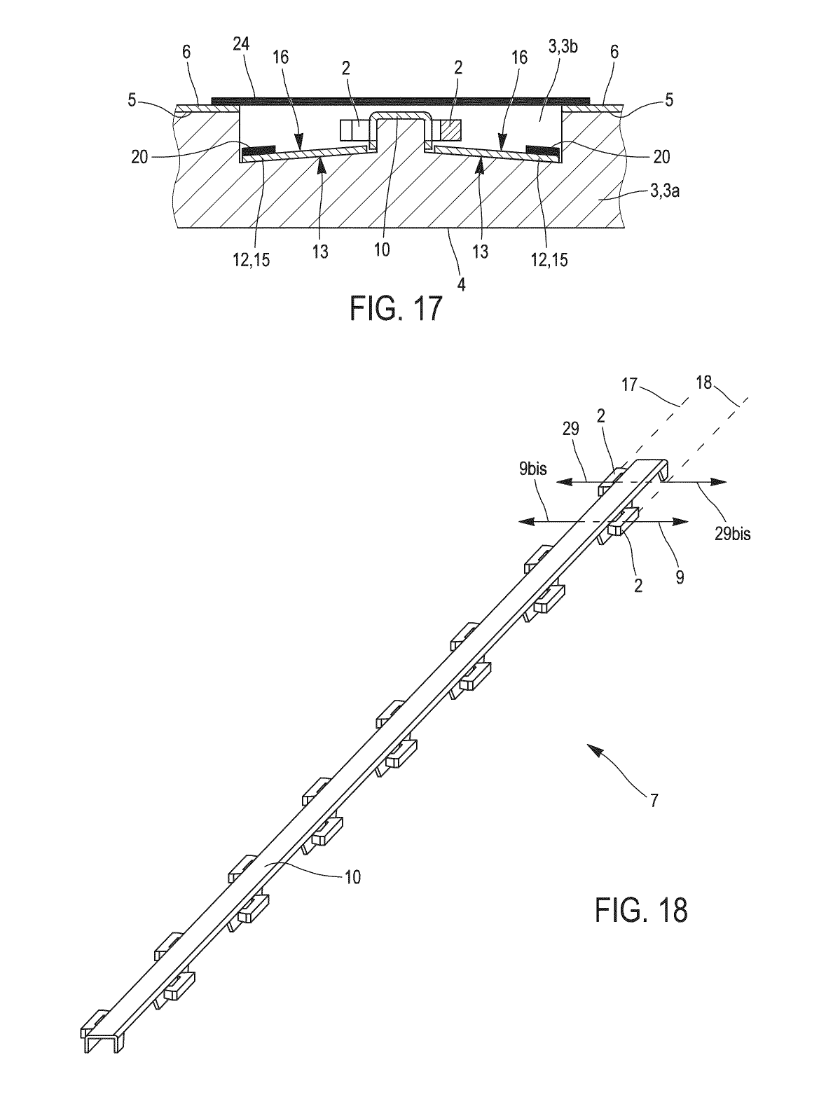

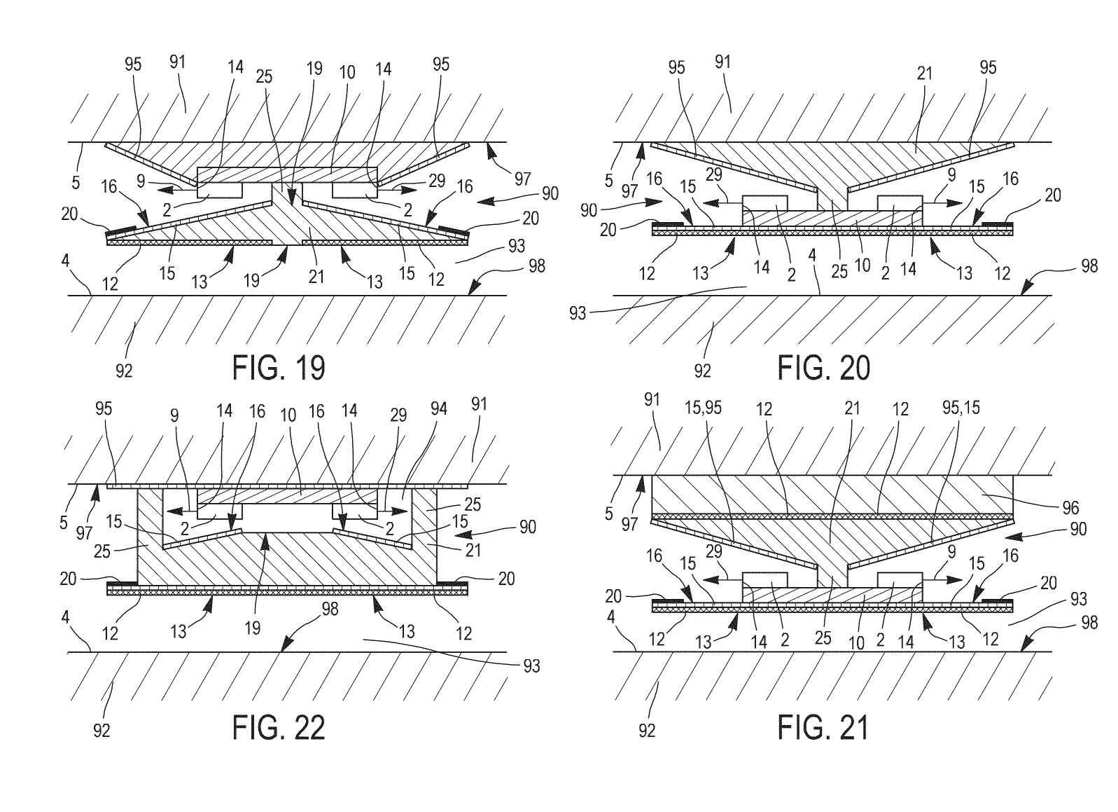

As illustrated in FIG. 17, for any embodiment or alternative of the module according to the invention, each strip 7 of “side view” sources which is illustrated in FIG. 2 can be replaced by a strip of “front view” sources 2 such as illustrated in FIG. 18. FIG. 17 illustrates the particular case of such a replacement from the module of FIG. 3.

A source 2 is called “front view” when it is arranged to emit light in a direction of emission 9 or 29 substantially perpendicular to the portion of the circuit 10 which carries said emitting source.

FIG. 18 is a three quarter view of a strip of “front view” LED. As illustrated, the rows of sources can be back-to-back (direction of emission 29 or 9) or face-to-face (direction of emission 29bis and 9bis).

Throughout this document, the use of the word “each” means each element considered, without excluding the existence of other different elements. For example, when it is said that the module according to the invention further comprises for each light source 2 a transmitting reflector, this means for each source 2 considered; it would indeed be possible to add to the module additional sources non-associated with reflectors and having their own roles, while keeping within the scope of the invention.

It will now be described, in reference to FIGS. 19 to 22, different steps of another method for making the module according to the invention applicable to any module previously described in reference to FIGS. 3 to 8. In particular, FIGS. 19 to 22 include some reference numerals already previously described which will therefore not necessarily be described again. FIGS. 19 to 22 only represent part of the module according to the invention when it is being made, this part comprising a single strip 7 of sources 2.

In this making method according to the invention, at least one assembly 90 (preferably several parallel assemblies so as to comprise several parallel strips 7) is placed in a space 93 bounded between planar surfaces 97, 98 of both plates 91, 92. The plates 91, 92 are preferably glass plates.

The surfaces 97 and 98 are facing each other.

The surfaces 97 and 98 are parallel.

The surface 97 of a first 91 of these plates bounds the return face 5.

The surface 98 of a second of these plates bounds the transmitting face 4.

Both plates 91, 92 are connected by a seal (not illustrated) closing the space 93.

Each assembly 90 comprises a strip 7 of sources 2 (integral with each other) such as described above with its two parallel rows of sources arranged to emit along the opposite directions 9, 29. The sources of an assembly 90 are preferably carried by a circuit 10. Further, each assembly 90 comprises for each of its sources a transmitting 12 and/or return 15 reflector such as described above (according to the different possible alternatives: discontinuous areas, reflecting strip common to several rows of sources, one reflecting strip per row, . . . ). For each assembly 90, its rows of sources are integral with its reflectors 12, 15.

Once it is placed between both plates 91, 92, the transmitting reflector 12 associated with one source has a reflecting face 13 directed towards the transmitting face 4 so that the transmitting reflector associated with this source is located between the transmitting face 4 and an emitting surface 14 of this source arranged for the output out of the source of the light emitted by the source.

Once it is placed between both plates 91, 92, the return reflector 15 associated with one source has a reflecting face 16 directed towards the return face 5 so that the emitting surface 14 of this source is located between the return reflector 15 associated with this source and the return face 5.

The surface 97 of the plate 91 bounding the space 93 is in contact with each assembly 90.

The surface 98 of the plate 92 bounding the space 93 is not in contact with any assembly 90.

Once the assemblies 90 are placed between the plates 91, 92, the space 93 is filled with an initially liquid or pasty material to form the light guide 3.

Then, this material is solidified, typically by polymerization preferably by heating. The guide 3 becomes integral with each assembly 90.

This material of the guide 3 preferably comprises PMMA (polymethylmethacrylate), PolyCarbonate (PC) and/or polyester. The preferred solution comprises PPMA, which typically polymerizes from 50 to 65° C. overnight and then at 120° C. for one hour.

Then, the plates 91 and 92 which therefore have been used as a mould are removed (at room temperature typically at 20° C.). Thus, the guide 3 is demoulded by removing it from between both surfaces 97, 98.

Thus, the module according to the invention can be ingeniously made by a single moulding, without necessarily needing to make cavities to place the sources 2, which enables the manufacturing cost to be reduced. This moulding further enables the optical continuity of the guide 3 to be improved, because it avoids re-sealing a cavity with possible resealing imperfections. This moulding can be made in one go by directly integrating the reflectors 12, 15.

According to one embodiment of FIG. 19 or 22, for each assembly 90, each transmitting reflector and each return reflector are located on two opposite faces of a same object 21 such as a film or a profile. This object (profile illustrated in FIG. 19 or 22) is preferably transparent. This object is preferably a profile 21 (for example of solvent resistant PET) which is integral with sources 2 (or even in contact with circuit 10) through at least one rib 25 of the profile 21. Each rib 25 is also transparent so as not to block the light flow in the plane of the guide. Once they are placed between both plates 91, 92, for each strip of sources, the emitting sources of the strip of sources are comprised between the transmitting face 4 and the circuit 10 of this strip of sources.

According to one embodiment of FIG. 20 or 21, once it is placed between both plates 91, 92, and for each strip of sources, the circuit of the strip of sources is comprised between the transmitting face and the emitting sources of this strip of sources. It is noted that in this case, the modules of FIGS. 5, 6, 7 and 8 should be completed at each strip 7 of sources by a rib 25 connecting the circuit 10 of this strip 7 to the surface 97 bounding the return face 5. Such an embodiment offers a better tightness of the module according to the invention, and prevents that the outside moister from reaching the electric circuit 10.

According to one embodiment of FIG. 19, 20 or 21, the space 93 is thus filled so that the emitting sources 2 are located in the guide 3 without intermediate space between the guide 3 and the emitting sources 2, in particular without vacuum, air or gas space.

According to one embodiment of FIG. 22, for each assembly 90, the sources 2 of the strip 7 of this assembly are located in a cavity 94 bounded by the profile 21, such that even after filling the space 93, the emitting sources 2 are located in the guide 3 with an intermediate vacuum, air or gas space (inside the cavity 94) between the guide 3 and the emitting sources 2. This facilitates maintenance of the module according to the invention, to replace the strips 7 of sources 2.

According to one embodiment of FIG. 19, 20, 21 or 22, each assembly 90 can further comprise a further reflector 95 (preferably of metal) arranged to reflect light towards the transmitting face 4 and located between the return face 5 and the return reflector 15, preferably between the return face 5 and the face 14 of each source 2.

According to one embodiment of FIG. 21, each assembly 90 can further comprise a thickness 96 of transparent material located between the return face 5 and the sources 2 of the assembly. This enables a “double face” module where each face 4 and 5 has a light transmission function. Each assembly 90 then comprises on either side of its strip of sources 2 a couple of transmitting 12 and reflecting 15 reflectors.

In an interesting alternative of the invention, each strip 7 of sources can be equipped at one of its ends with an electric connector (or “electric contact”). After solidification of the material forming the guide 3, each of these connectors is accessible by being released by a cutting along this connector. The cutting is preferably a laser cutting. Optionally, a pocket of air or of another material different from that of the guide 3 and extractible from the guide 3 can be provided at each connector to make it appear.

In one alternative, the faces 4 and 5 are not necessarily parallel. One of the faces 4, 5 can be not parallel to the other face, or have a saw tooth shape.

Of course, the invention is not restricted to the examples just described and numerous alterations can be provided to these examples without departing from the scope of the invention.

Of course, the different characteristics, forms, alternatives and embodiments of the invention can be associated with each other.

1. A lighting module comprising:
at least one strip of light emitting sources,
a light guide comprising a transmitting face arranged to transmit to an object to be lit, the light emitted by the emitting sources and a return face facing the transmitting face,
the emitting sources being located inside the light guide,
characterised in that it further comprises for each light source, a transmitting reflector associated with this source and having a reflecting face directed towards the transmitting face so that the transmitting reflector associated with this source is located between the transmitting face and an emitting surface of this source arranged for the output out of the source of the light emitted by this source.

2. The module according to claim 1, characterised in that each strip of sources comprises at least one row of light sources emitting light substantially in a same direction of emission.

3. The module according to claim 2, characterised in that each strip of sources further comprises a second row of light sources, the sources of the first row emitting light in a direction of emission substantially opposite to a direction of light emission of the sources of the second row.

4. The module according to claim 1, characterised in that it further comprises for each light source a return reflector associated with this source having a reflecting face directed towards the return face so that the emitting surface of this source is located between the return reflector associated with this source and the return face.

5. The module according to claim 4, characterised in that for each light source, the associated transmitting reflector and return reflector are located on two opposite faces of a same object such as a film or profile.

6. The module according to claim 4, characterised in that for each source, the reflecting face of the return reflector associated with this source is tilted so that the distance between the return face and this reflecting face is increasing as the distance from the strip carrying this source increases.

7. The module according to claim 4, characterised in that for each strip of sources, the return reflectors of different sources form mutually discontinuous reflecting areas.

8. The module according to claim 4, characterised in that for each strip of sources, the return reflectors of different sources form a continuous reflecting strip running along the source rows of the strip of sources and common to all these rows.

9. The module according to claim 4, characterised in that for each strip of sources, the return reflectors of the different sources form a continuous reflecting strip per source row of the strip of sources, each reflecting strip running along its row, the reflecting strips of a same strip of sources being spaced by a non-reflecting intermediate space letting the light through.

10. The module according to claim 8, characterised in that each reflecting strip is provided, along its edge farthest from the light sources of this strip of sources, with a non-reflecting dark strip arranged to absorb light emitted by the sources.

11. The module according to claim 1, characterised in that each strip of sources comprises a power supply circuit carrying the sources of this strip of sources, and in that for each strip of sources, the emitting sources of the strip of sources are included between the transmitting face and the circuit of this strip of sources.

12. The module according to claim 1, characterised in that each strip of sources comprises a power supply circuit carrying the sources of this strip of sources, and in that for each strip of sources, the circuit of this strip of sources is included between the transmitting face and the emitting sources of this strip of sources.

13. The module according to claim 1, characterised in that each transmitting reflector is integrated in the module so that there is no intermediate space, in particular no vacuum, air or gas space, between the light guide and each transmitting reflector.

14. The module according to claim 1, characterised in that each transmitting reflector has a convex shape towards the transmitting face.

15. A method for making a module according to claim 1, characterised in that it comprises the following steps:
in a space bounded between two surfaces at least one assembly is placed, a first of these surfaces bounding a return face, a second of these surfaces bounding a transmitting face, each assembly comprising:
a strip of light emitting sources, and
for each of the sources of this strip, a transmitting reflector associated with this source and having a reflecting face directed towards the transmitting face so that the transmitting reflector associated with this source is located between the transmitting face and an emitting surface of this source arranged for the output out of the source of the light emitted by this source,
the space is filled with an initially liquid or pasty material to form a light guide, so that the emitting sources are located inside the light guide,
this material is solidified, and
the guide, integral with each assembly, is demoulded by removing it from between both surfaces.

16. The method according to claim 15, characterised in that each assembly further comprises, for each of its sources, a return reflector associated with this source having a reflecting face directed towards the return face so that the emitting surface of this source is located between the return reflector associated with this source and the return face.

17. The method according to claim 16, characterised in that for each assembly, the transmitting reflectors and the return reflectors associated with all the sources of an assembly are located on two opposite faces of a same object such as a film or a profile.

18. The method according to claim 15, characterised in that the surface bounding the return face is in contact with each assembly.

19. The method according to claim 15, characterised in that the surface bounding the transmitting face is not in contact with any assembly.

20. The method according to claim 15, characterised in that each strip of sources includes at least one first row of light sources emitting light substantially in a same direction of emission, and further a second row of light sources, the sources of the first row emitting light in a direction of emission substantially opposite to a direction of light emission of the sources of the second row.

21. The method according to claim 15, characterised in that each assembly further comprises a power supply circuit carrying the sources of the strip of sources of this assembly.

22. The method according to claim 21, characterised in that for each strip of sources, once it is placed between both surfaces, the circuit of the strip of sources is comprised between the transmitting face and the emitting sources of this strip of sources.

23. The method according to claim 21, characterised in that for each strip of sources, once they are placed between both surfaces, the emitting sources of the strip of sources are comprised between the transmitting face and the circuit of this strip of sources.

24. The method according to claim 15, characterised in that the surfaces are connected by a seal closing the space.
